(19) United States
(12) Patent Application Publication
(10) Pub. No.: US 2013/0021604 A1
(43) Pub. Date: Jan. 24, 2013

(54) Automated Sample Positioning System For Ellipsometers

(71) Applicant: Richard Sun, Acton, MA (US)

(72) Inventor: Richard Sun, Acton, MA (US)

(21) Appl. No.: 13/187,485

(22) Filed: Jul. 20, 2011

(51) Int. Cl. G01N 21/01

(52) U.S. Cl. 356/244

(57) ABSTRACT

An automated 450 mm wafer sample stage for ellipsometers. The sample stage includes a plurality of sample support pins and sample guides for precision positioning. The sample support pins and sample guides may be mounted on the same holding arm which is electronically controlled by a computer user interface. The sample support pins and sample guides are raised to a predefined height to allow sufficient space for a 450 mm be transferred with a vacuum wand onto the support pins and position guides. By electronically lowering the support pins below the surface of the sample stage plate, the 450 mm wafer is placed on the ellipsometer's sample stage without any stress to the wafer surface.

### DESCRIPTION OF RELATED ART

The present application relates to a wafer measurement device, and more particularly to a spectroscopic ellipsometer having an automated sample positioning system mounted on a measurement stage plate.

Note that the points discussed below may reflect the hindsight gained from the disclosed inventions, and are not necessarily admitted to be prior art.

Ellipsometers have been utilized to obtaining a variety of fundament physical parameters of a thin film by measuring a complex refractive index or dielectric function of the thin film. The parameters may include morphology, crystal quality, chemical composition and electrical composition, etc. It is commonly used to characterize film thickness ranging from a few angstroms to several micrometers with an excellent accuracy. Its usage ranges from semiconductor to microelectronics and biology, from basic research to industrial applications.

Ellipsometers have been used for wafer quality control during silicon wafer manufacturing and production. Conventional wafers are produced at the standard 300 mm size, however, transition to 450 mm standard production size is emerging since 450 mm wafers enable semiconductor manufacturers to reduce costs. About 2.25 times more chips can be made on a 450 mm wafer compared to a 300 mm wafer. Recently, SEMI has published a set of new standards for manufacturing and handling 450 mm wafers. There will be great need for 450 mm wafer handling tools and measurement systems. Especially a 450 mm wafer capable Ellipsometer is needed for 450 mm wafer's quality control and measurement.

A 450 mm wafer, because of its big diameter, may be deformed by the handling stress and gravity during loading and unloading processes of a testing cycle. A conventional Ellipsometer that performs 300 mm wafer measurement is not suitable for 450 mm wafers for the reason that it does not have a suitable sample stage that allows for loading and unloading a 450 mm wafer with sufficiently safety and low stress.

### SUMMARY

The present application discloses a novel automatically controlled sample stage design for an Ellipsometer for loading and unloading large samples with sufficient low stress.

In one embodiment, at least three evenly spaced sample support pins are slidingly disposed below the surface of a flat sample stage plate. Upon operation for sample loading, the supporting pins are raised to a predefined height, allowing sufficient space for a wafer wand to load a wafer onto the supporting pins. Sliding the supporting pins below the surface the flat sample stage plate places the wafer gently and evenly onto the flat sample stage plate without any stress or damage or defects exerted to the wafer.

In one embodiment, at least three evenly spaced L shaped sample guides are slidingly mounted at the peripheral edge of the flat sample stage plate. Upon operation for sample loading, the guides are raised to a predefined height and the edges of the guides push a sample towards the center, positioning the sample to the center of the sample stage plate.

In one embodiment, a sample support pin and a sample guide are mounted together and are automatically controlled by the same motor mechanism with an integrated commanding process.

The disclosed innovation, in various embodiments, provide an integrated automatic sample loading and unloading process for safe handling of large samples for Ellipsometry measurement and for other 450 mm wafer measurement tools. This innovation is particularly useful for 450 mm silicon wafer quality control in manufacturing and production using Ellipsometers as described in US Patent Application Publications. US 2006/0066854 A1 and US 2002/0102748 A1

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 shows a front view of an example Ellipsometer capable of loading and unloading large samples in accordance with this application.

FIGS. 2A and 2B show perspective and cutaway views of an example Ellipsometer capable of loading and unloading large samples in accordance with this application.

FIG. 3A shows a top view of an example Ellipsometer capable of loading and unloading large samples in accordance with this application.

FIG. 3B shows a bottom view of an example Ellipsometer capable of loading and unloading large samples in accordance with this application.

FIG. 4A shows a prior art sample stage plate of an Ellipsometer.

FIG. 4B shows a sample stage plate having three built-in support pins of an example Ellipsometer capable of loading and unloading large samples in accordance with this application.

FIG. 5A shows a front sectional view of a sample stage plate of FIG. 4B loaded with a large sample in accordance with this application.

FIG. 5B shows a front sectional view of a sample stage plate of FIG. 5A loaded with a large sample at the pin-down position in accordance with this application.

FIG. 5C shows a partial view of the sample guide structure of a sample stage plate of FIG. 5B in accordance with this application.

FIG. 6A shows a cutaway drawing of a sample stage plate having sample support pins and sample guides of an example Ellipsometer capable of loading and unloading large samples in accordance with this application.

FIG. 6B shows a front sectional view of a sample stage plate of FIG. 6A loaded with a large sample in accordance with this application.

FIGS. 7A and 7B show top views of alternative designs of a sample stage plate of an Ellipsometer capable of loading and unloading large samples in accordance with this application.

FIG. 8A shows a top view of an example support pin and a sample guide as configured in FIG. 7A.

FIG. 8B shows partial view of an example support pin and a sample guide structure of FIG. 8A.

FIG. 8C shows a cutaway drawing of a top view of an example support pin and a sample guide mechanism as configured in FIG. 8B.

FIG. 8D shows a cutaway drawing of an example support pin and sample guide of FIG. 8A at pin-down position in accordance with this application.

FIG. 9A shows a top view of a sample stage of FIG. 8A loaded with a large sample in accordance with this application.

FIG. 9B shows a partial front sectional view of a support pin and sample guide structure at the pin-up position loaded with a large sample in accordance with this application.

FIG. 9C shows a partial front sectional view of a support pin and sample guide structure at the pin-down position loaded with a large sample in accordance with this application.

FIG. 10 shows a functional flow chart of an example controlling process for loading and unloading large samples of an Ellipsometer in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the disclosed design apply to all types of ellipsometers for handling stress sensitive samples, for example, single angle ellipsometers, multi-angle ellipsometers, interferometers, spectral reflectometers, etc.; for clarity reason, the examples are given based on a multi-angle ellipsometer using 450 mm silicon wafers as samples. The sample stage may also be used for other metrology tools for large samples, for example, resistance measurement tools, defect inspection tools for 450 mm wafers. An ordinary person in the art would know the variations to modify the design to adapt to measurement of other types and other sizes of stress sensitive samples.

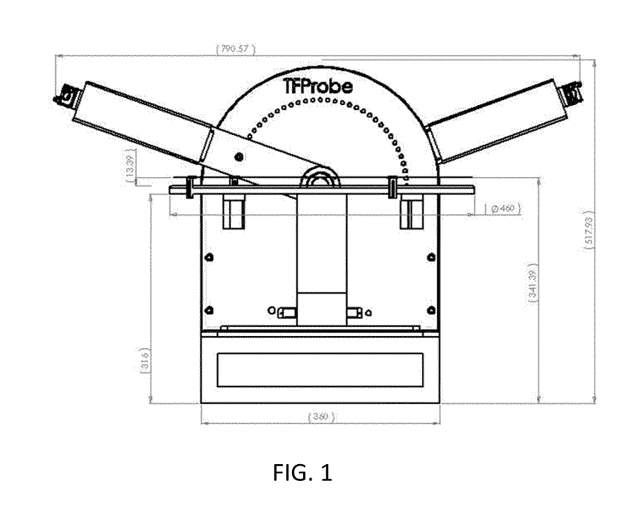

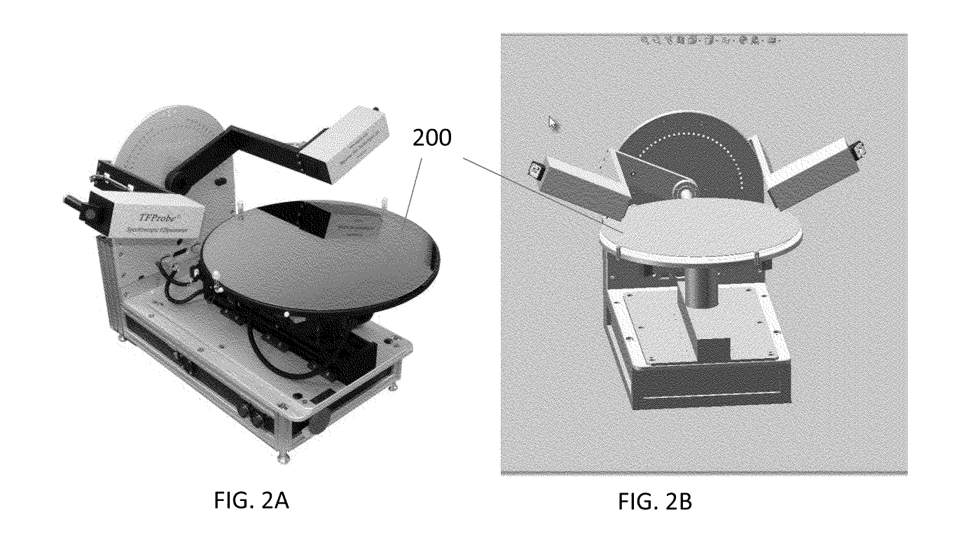

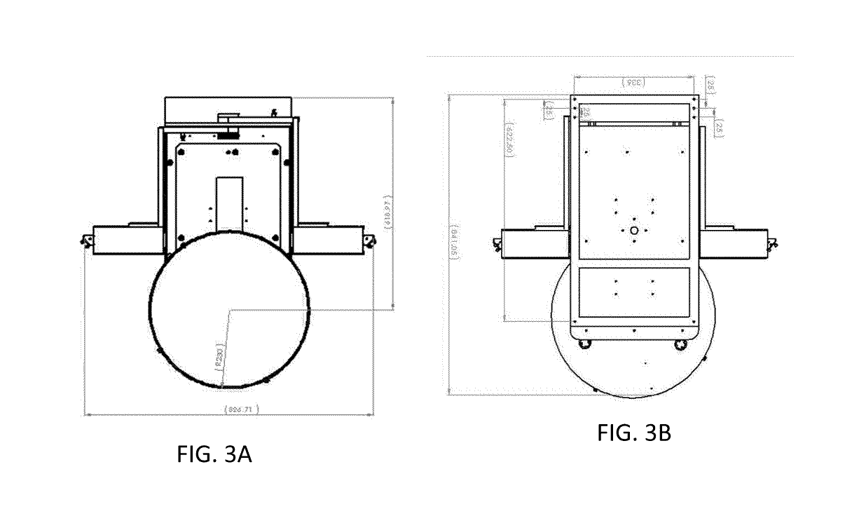

In reference to FIG. 1, it shows an example TFProbe® ellipsometer designed by Angstrom Sun Technologies that has a large sample stage for measuring large samples, including 450 mm silicon wafers. In reference to FIGS. 2A and 2B, 3A and 3B, large sample stage 200 may be positioned for sample loading (FIGS. 2A, 3A and 3B) or sample measuring (FIG. 2B). The positioning of the sample stage for sample loading and sample measurement may be electronically controlled and a part of an automated sample handling process. Sample stage 200 at least includes a flat circular stage plate that is about or bigger than a 450 mm wafer, a sample support and guide mechanism for safe loading and centralizing a sample.

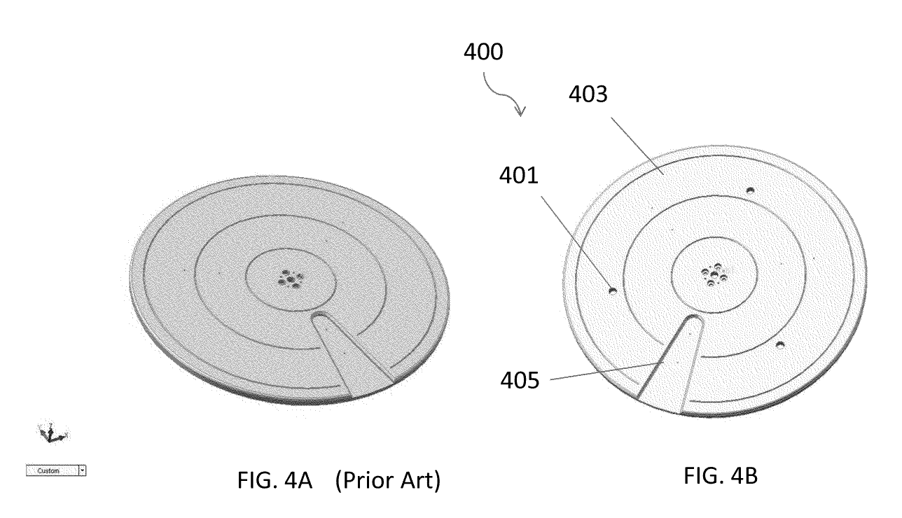

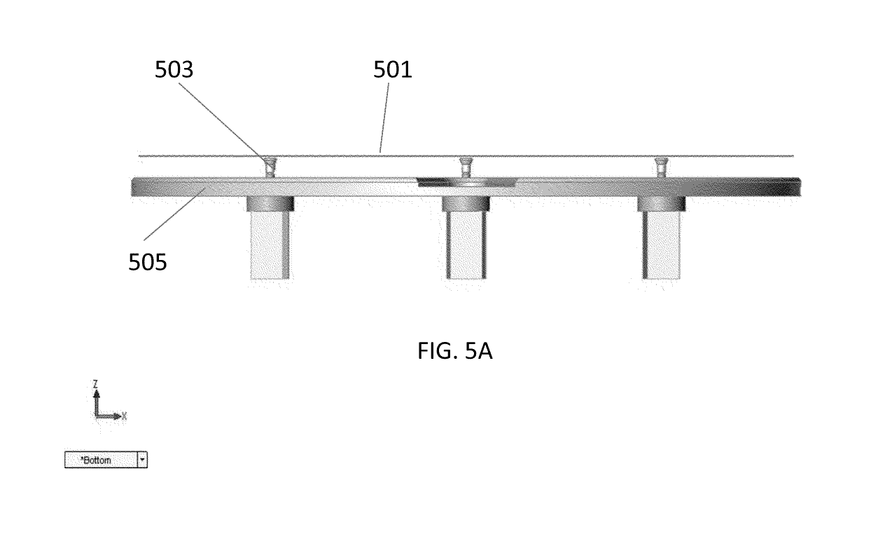

In reference to FIG. 4A, for loading a wafer sample onto a sample stage plate, the stage plate conventionally has a grooved section forming a lowered space for releasing a wafer suction wand after loading a wafer with the wand. However due to the large size of 450 mm wafers, such groove does not form sufficient space for transferring a 450 mm wafer to the sample stage plate without stressing or deforming the 450 mm wafer. To solve this problem, in reference to FIG. 4B, a set of sample support pins 401 are slidingly disposed into sample stage plate 403, which can be raised to form sufficient space for releasing a suction wand in supporting a sample. Optionally groove 405 may be added on a sample stage plate for handling smaller sized samples.

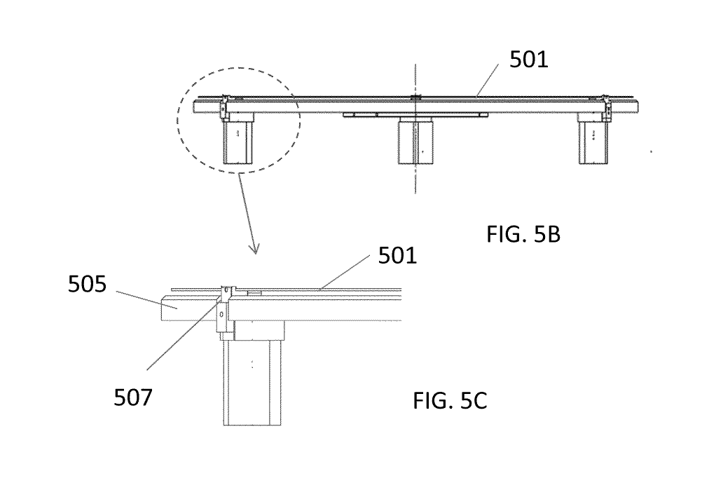

In reference to FIG. 5A, it shows a front cross sectional view of a sample loading configuration of an example sample stage plate of FIG. 4B. When loading a large sample, for example, a 450 mm silicon wafer to an ellipsometer for measurement, at least three evenly positioned sample support pins 503 are raised to a predefined height from sample stage plate 505, allowing sufficient space to place a 450 mm wafer sample 501 safely on the support pins with a wafer wand.

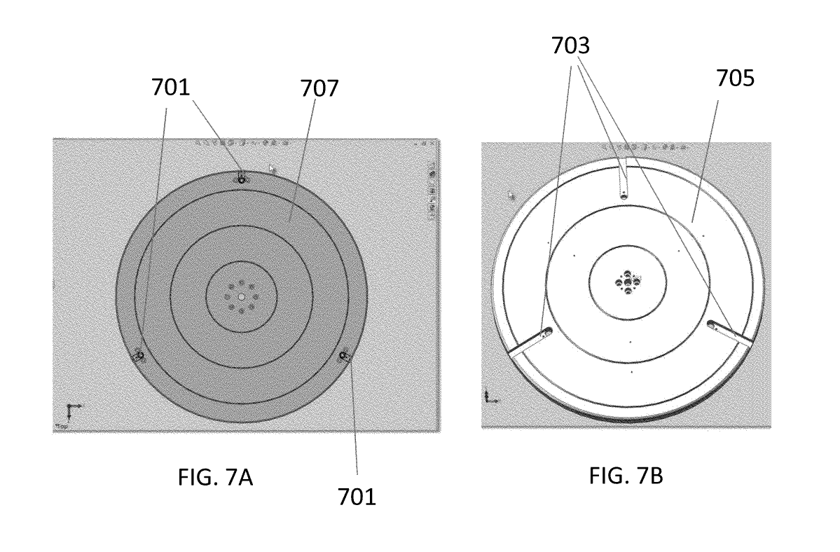

Once sample 501 is placed on support pins 503, support pins 503 are commanded to slide below the surface of sample stage plate 505 as shown in FIGS. 5B and 5C, gently placing sample 501 on the top of sample stage plate 505 for measurement. The position of sample 501 may be adjusted with a plurality of sample guide mechanism 507. Sample guides 507 usually are configured to form a L-shaped chair structure that gently presses sample 501 towards a predefined position on sample stage plate 505 with precision. Sample guides 507 may be preferably attached to the peripheral edge of sample stage plate 505. Alternatively, the sample guides may be mounted to a pre-defined position on sample stage plate 505 by configuring sample stage plate with a groove like structure 703 as shown in FIG. 7B.

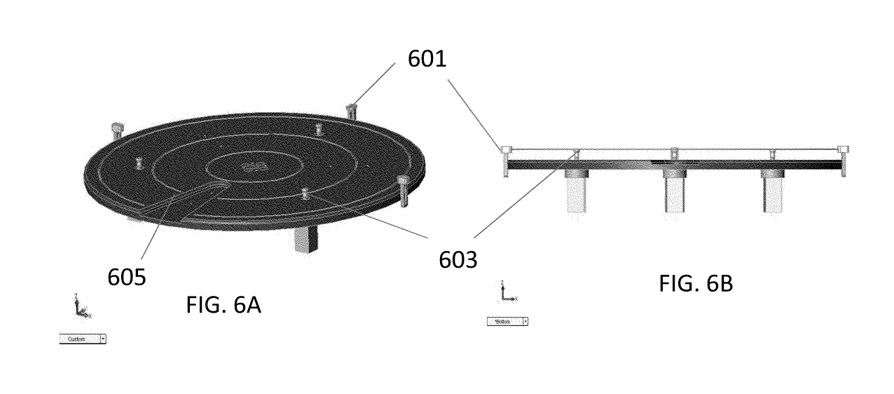

FIGS. 6A and 6B show that the position of sample 607 may be adjusted with a few detachable sample guides 601. Detachable sample guides 601 may be made of magnetic material that can be manually attached to the iron containing peripheral edge of sample stage plate 505.

Alternatively, a sample support and a sample guide may be configured as one integral functional mechanism as shown in FIG. 7A. On sample stage plate 707, three sample support and sample guide mechanisms 701 are disposed evenly either around the peripheral edge of sample stage plate 707, or adjustably disposed as shown in FIG. 7B with a sliding trail 703 on the sample stage plate in controlling their mounting positions.

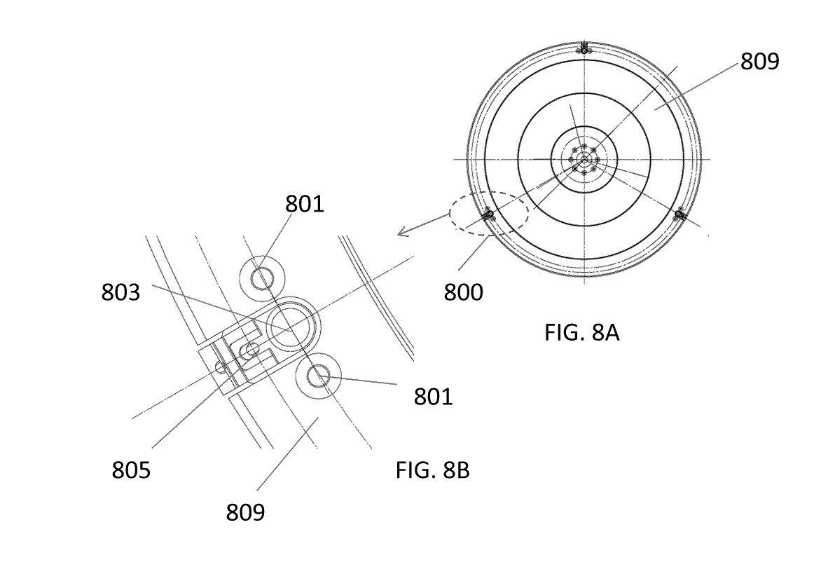

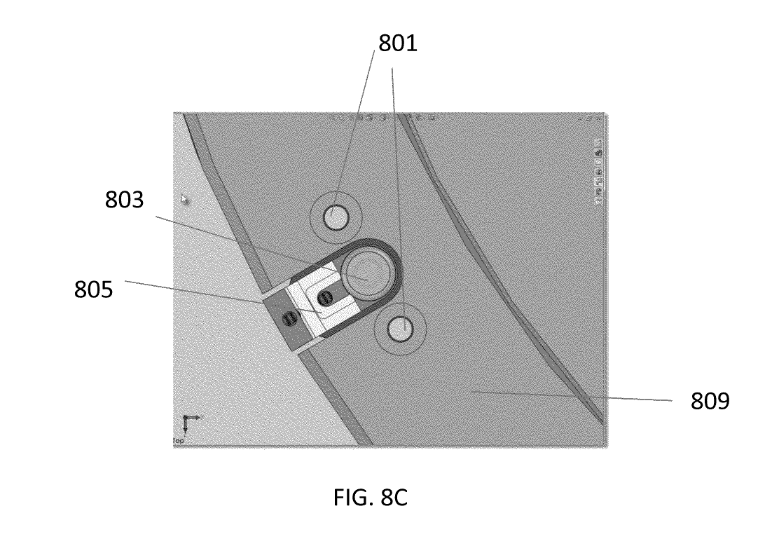

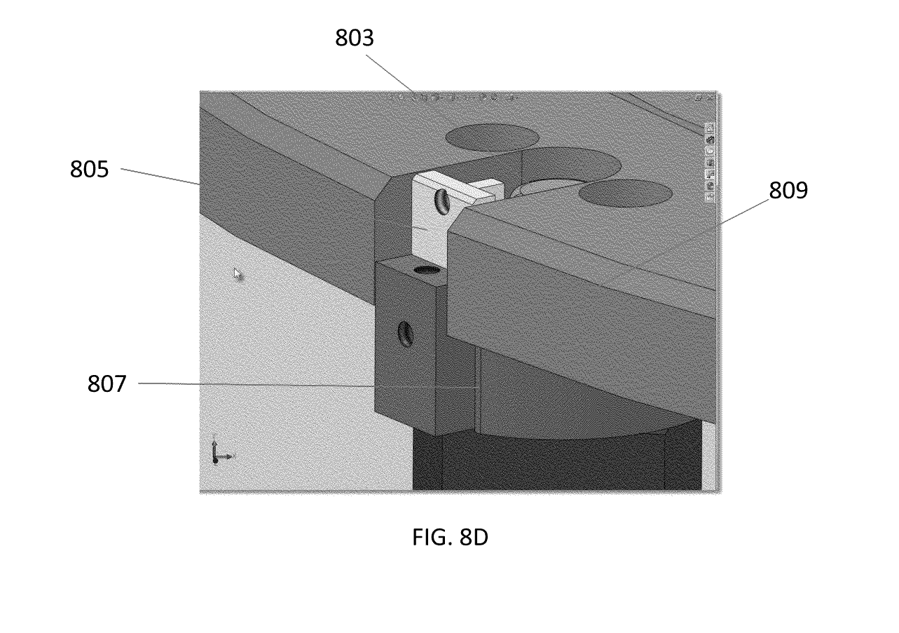

In reference to FIGS. 8A, 8B, 8C and 8D, an example integrated sample support and sample guide mechanism includes at least one sample support 803, optionally with two flanking supports 801, and a sample guide assembly 805 mounted adjacent to sample support 803. Sample support 803 and sample guide 805 are then installed on holding arm 807 as a unit on sample stage plate 809. Sample guide 805 forms a L shaped support chair structure with the edge of the seat matching to the edge of a particular sample for aligning the sample. Preferably at least three sample support and guide unit are slidingly mounted around the peripheral edge of sample stage plate 809. The plurality of sample supports and sample guides are evenly spaced around the peripheral edge of the stage plate in order to balance a sample.

The support and guide unit is mounted on a holding arm 807 that is controlled by a moving mechanism. For example, arm 807 may be controlled by a stepping motor. Alternatively holding arm 807 may be controlled by compressed air cylinder or a Linear Piezoelectric actuator. The moving mechanism may be electronically controlled by commands from a computer with a user interface. The computer may be a personal computer or a built-in computing module in a Ellipsometer machine. When commands for loading a sample is entered, the stepping motor will raise holding arm 807, which in turn raises sample support and sample guide unit 803 and 805.

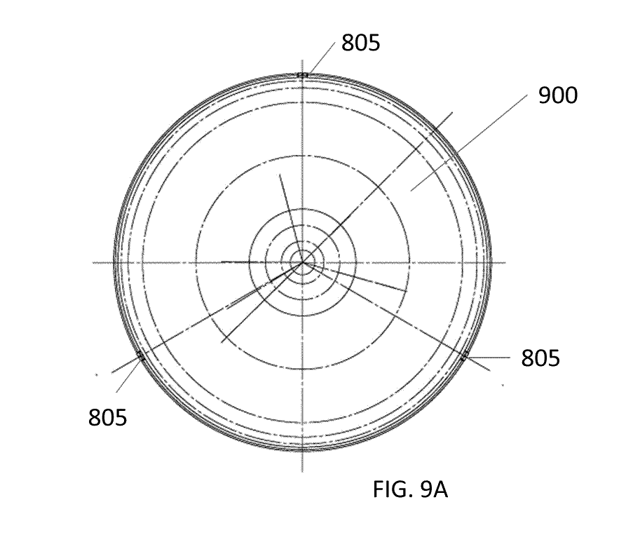

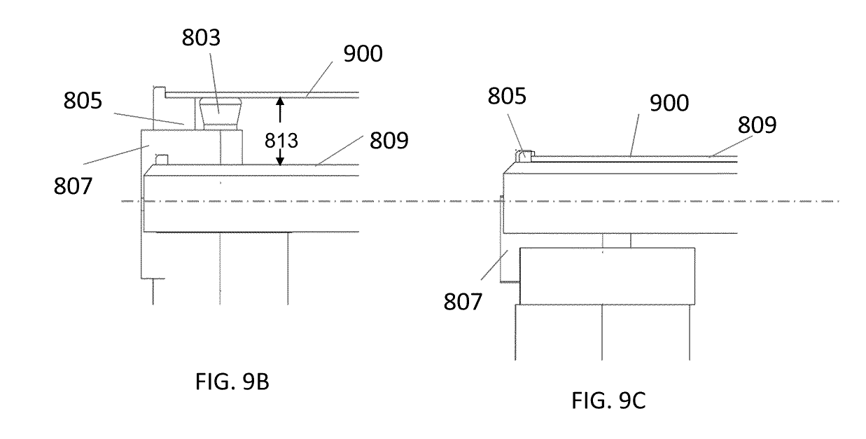

FIGS. 9A and 9B illustrate that after sample support and sample guide unit 803 and 805 are raised to a predefined height 813 above stage plate 809, an operator places a sample 900 on support 803, and the position of sample 900 is adjusted by physically touching guide 805. Height 813 sufficiently allows a sample wand for safely transferring a sample back and forth from the sample stage. After the sample is positioned according to predefined requirement, as shown in FIG. 9C, sample guide unit 803 and 805 are slid below the surface of stage plate 809 by holding arm 807, gently leaving sample 900 on the top of stage plate 809 for ellipsometry measurement.

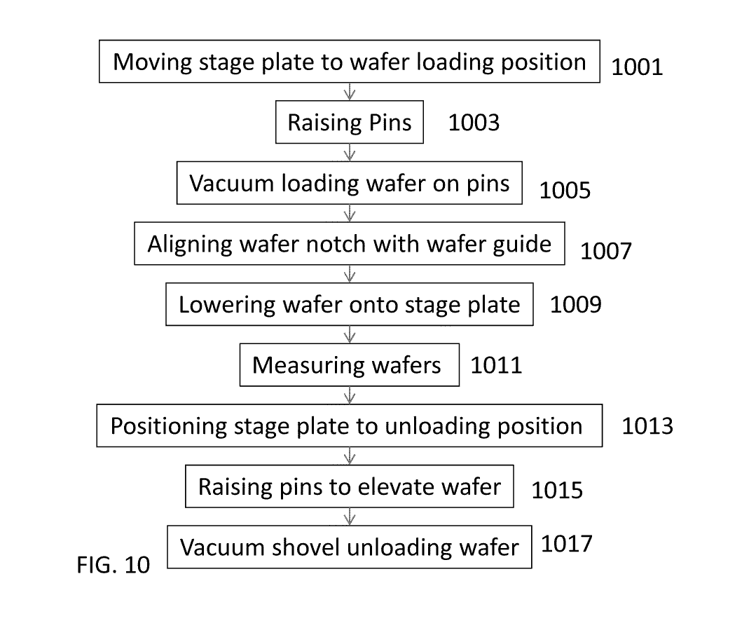

In reference to FIG. 10, the sample loading process may be controlled by a computer software through computer processors and pre-programmed microchips installed on the stepping motor and a computer with a user interface. The computer may be a personal lap top or a specifically made computer unit for this use. The communication between the motor and the computer commanding process may be through a wireless communication or electronic cables.

For the commanding process, at step 1001, the motor moves the stage plate to sample loading position by moving the stage forward from underneath light beam (FIG. 3A). At step 1003, the stepping motor moves the holding arm to raise the sample support pins and sample guides to a predefined height. At step 1005, an operator loads a sample onto the top of the support pins. In case of a 450 mm wafer, the wafer is vacuumed up with a wafer wand and placed onto the support pins by releasing the vacuum. At step 1007, the sample is aligned with the sample guides. At step 1009, the support pins and guides are slowly and evenly lowered below the top surface of the stage plate, placing the sample onto the top of the stage plate without any stress to the sample. At step 1011, the stage plate is moved back to measurement position, and the sample is scanned with the ellipsometer light beam, and complex refractive index or dielectric parameters are collected. At step 1013, the stage plate is then positioned forward to the same position as loading position. At step 1015, the support pins are raised, elevating the sample to the predefined unloading height. At step 1017, an operator transfers the sample to storage with a sample wand. For 450 mm silicon wafers, a vacuum shovel holds the wafer sample with vacuum suction, and moves the wafer to storage cassette. An operator may either be a human operator or a robot.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following publications, all of which are hereby incorporated by reference herein for all purposes: US Patent Application Publication No. US 2006/0066854 A1 and US 2002/0102748 A1. A person in the art will know the necessary modifications for moving the sample support pin and sample guide mechanisms up and down with either step motor, a Compressed Air Cylinder or a Linear Piezoelectric actuator.

Additionally this wafer handling method can be used or implemented for other metrology tools for large samples, for example resistance measurement tool, defect inspection tools for 450 mm wafers.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. An ellipsometer having an automated sample stage for sample loading, comprising:
a flat stage plate forming a plurality of balancedly positioned apertures on the stage plate;
a plurality of sample loading units, each slidingly mounted inside said respective individual apertures;
a moving mechanism being electronically controlled by a microprocessor, physically linked with said plurality of sample loading units, configured to raise and lower said loading units to a predefined length; and
a user interface module being electronically connected with said microprocessor, allowing an operator to give commands.

2. The ellipsometer of claim 1, wherein at least one of sample loading units comprises a sample support pin and a sample guide, being physically mounted adjacent to each other forming a chair-like structure, with said sample support pin being a seat-like and said sample guide being chair-back like.

3. The ellipsometer of claim 2, wherein said sample guide has a screw-like mounting arm being mountable to said sample loading unit with a screw driver.

4. The ellipsometer of claim 1, wherein at least one of said apertures form an elongated track, and a respective loading unit mounted inside said elongated aperture is configured to move along said aperture in adjusting to a sample size.

5. The ellipsometer of claim 1 wherein said stage plate having a peripheral edge, further comprising a detachable sample guide attachable to said peripheral edge, whereby providing positioning guide to a sample on top said loading units.

6. The ellipsometer of claim 1, wherein said stage plate accommodates to a 450 mm silicon wafer.

7. The ellipsometer of claim 1, wherein said moving mechanism is a step motor.

8. The ellipsometer of claim 1, wherein said moving mechanism is a compressed air cylinder.

9. The ellipsometer of claim 1, wherein said moving mechanism is a Linear Piezoelectric actuator.

10. A 450 mm wafer automated handling stage for metrology tools, comprising:
a flat stage plate forming a plurality of balancedly positioned apertures on the stage plate;
a plurality of sample loading units, each slidingly mounted inside said respective individual apertures;
a moving mechanism being electronically controlled by a microprocessor, physically linked with said plurality of sample loading units, configured to raise and lower said loading units to a predefined length; and
a user interface module being electronically connected with said microprocessor, allowing an operator to give commands.

11. The 450 mm wafer automated handling stage of claim 10, wherein at least one of sample loading units comprises a sample support pin and a sample guide, being physically mounted adjacent to each other forming a chair-like structure, with said sample support pin being a seat-like and said sample guide being chair-back like.

12. The 450 mm wafer automated handling stage of claim 11, wherein said sample guide has a screw-like mounting arm being mountable to said sample loading unit with a screw driver.

13. The 450 mm wafer automated handling stage of claim 10, wherein at least one of said apertures form an elongated track, and a respective loading unit mounted inside said elongated aperture is configured to move along said aperture in adjusting to a sample size.

14. The 450 mm wafer automated handling stage of claim 10, wherein said stage plate having a peripheral edge, further comprising a detachable sample guide attachable to said peripheral edge, whereby providing positioning guide to a sample on top said loading units.

15. The 450 mm wafer automated handling stage of claim 10, wherein said moving mechanism is a motor.

16. The 450 mm wafer automated handling stage of claim 10, wherein said moving mechanism is a compressed air cylinder.

17. The 450 mm wafer automated handling stage of claim 10, wherein said moving mechanism is a Linear Piezoelectric actuator.

18. A method for automatically handling a 450 mm wafer for a metrology tool, comprising the actions of:
electrically raising a plurality of balancedly placed sample loading units to a predefined height by a moving mechanism and a computer user interface;
transferring a 450 mm wafer with a robot vacuum wand to said sample loading units;
pressing said wafer with a sample guide to adjust said wafer by the moving mechanism and the computer user interface; and
lowering said plurality of balancedly placed sample loading units to below the surface of a sample stage plate by the moving mechanism and the computer user interface.

19. The method of claim 18, further comprising the action of:
raising the plurality of balancedly placed sample loading units to raise the wafer to a predefined height by the moving mechanism and the computer user interface.

20. The method of claim 18, wherein said loading unit and said sample guide are mounted adjacently on a holding arm.
